(19) United States
(12) Patent Application Publication
(10) Pub. No.: US 2026/0196211 A1
(43) Pub. Date: Jul. 9, 2026

(54) SYSTEMS AND METHODS FOR AUDIO RECOGNITION WITH FEATURE EXTRACTION AND STEERING IN AUDIO EMBEDDINGS

(71) Applicant: Vail Systems, Inc., Deerfield, IL (US)

(72) Inventors: Daniel Pluth, Riverside, IL (US); Zachary Nicholas Houghton, Arlington Heights, IL (US); Yu Zhou, Naperville, IL (US); Vijay K. Gurbani, Lisle, IL (US)

(21) Appl. No.: 19/443,706

(22) Filed: Jan. 8, 2026

Related U.S. Application Data
(60) Provisional application No. 63/743,071, filed on Jan. 8, 2025.

(51) Int. Cl. G10L 15/16; G10L 15/02; G10L 15/18

(52) U.S. Cl. CPC G10L 15/16; G10L 15/02; G10L 15/1815

(57) ABSTRACT

A system and method for extracting and steering audio features in audio embeddings for analyzing and processing audio. The system and method include an autoencoder having an input layer configured to receive a dense audio embedding representing the audio, an encoder that maps the dense audio embedding to a latent vector, an activator that constrains activations of the latent vector to a subset of indices, and a decoder that generates a reconstructed embedding from the constrained latent vector. The system and method further include an audio embedding decoder (AED) configured to analyze the reconstructed embedding and generate an audio-to-text transcript and/or provide identification data, including identification of at least one of (i) a source of the audio, (ii) one or more characteristics of the audio, and (iii) one or more characteristics of the source of the audio, and a communication unit configured to output or transmit the transcript and/or identification data to a communicating device.

### CROSS-REFERENCE TO RELATED APPLICATION

This application claims priority to and the benefit of U.S. Provisional Patent Application No. 63/743,071, filed Jan. 8, 2025, the entirety of which is incorporated herein by reference.

### FIELD OF THE DISCLOSURE

The present disclosure relates to machine learning systems and methods for audio processing, analysis, and/or recognition, including audio source recognition. More particularly, it concerns sparse autoencoder architectures and procedures that uncover audio features, including, for example, monosemantic features from audio embeddings and enable feature steering of reconstructed embeddings for improved interpretability and downstream control.

### BACKGROUND OF THE DISCLOSURE

Modern audio recognition systems often encode variable-length audio utterances into compact, dense audio embeddings. Some state-of-the-art (“SOTA”) systems can produce high-dimensional vectors by convolutional models with statistical pooling. Such embeddings are suitable for verification, transcription and identification tasks but are typically not interpretable, obscuring how attributes like language, music, voice, pitch, prosody, phonemes, semantics, or demographic characteristics influence predictions. As a result, small perturbations may cause undesired behavior in deep models.

There is an unfulfilled need for a solution that can disentangle and interpret latent attributes within audio embeddings and that can steer such attributes to analyze and control model behavior.

### SUMMARY OF THE DISCLOSURE

The disclosure provides systems and methods that overcome challenges faced by SOTA systems. The systems and methods of the disclosure provide interpretable control over dense audio embeddings and enable mechanisms to analyze, diagnose, and adjust model behavior in production audio systems. The systems and methods of the disclosure are configured to make audio recognition systems more transparent and controllable.

According to an aspect of the disclosure, a system is provided for extracting and steering audio features in audio embeddings for analyzing audio and processing the audio based on the analysis. The system comprises: an autoencoder having an input layer configured to receive a dense audio embedding representing the audio, an encoder that maps the dense audio embedding to a latent vector, an activator that constrains activations of the latent vector to a subset of indices, and a decoder that generates a reconstructed embedding from the constrained latent vector; an audio embedding decoder (AED) configured to analyze the reconstructed embedding and provide identification data, including identification of at least one of (i) a source of the audio, (ii) one or more characteristics of the audio, and (iii) one or more characteristics of the source of the audio; and a communication unit configured to output or transmit the identification data to a computing device.

In some embodiment, the system is configured to analyze the reconstructed embeddings and, based on the analysis, editing, mix, encrypt/decrypt, record, store, transcribe, route, or perform other handling or processing operations relating to the audio data and/or the input signal. In certain embodiments, the system comprises an automatic speech recognition (ASR) system and an audio processing unit (APU) that includes a Whisper transformer-based ASR (Automatic Speech Recognizer) model. The Whisper model is configured to transcribe and translate spoken words or sounds in a wide variety of languages, and to encode audio data. The Whisper model is configured to transcribe and translate (input audio, output text) audio data, and the APU is configured to recognize and identify numbers, profanities, and other classes of sounds or words, and process the audio data to redact, modify, correct, or replace certain words or sounds in the output transcript, which can then be transmitted or output, by a communication unit in the APU, to one or more communication devices.

The audio embedding decoder (AED) can be configured to identify a monosematic latent feature by correlating a latent index of the constrained latent vector with a target attribute of the audio. The activator can be configured to steer the reconstructed embedding by selectively activating or deactivating the identified latent index to change a relative similarity score of the reconstructed embedding with respect to reference centroids corresponding to different classes.

In some embodiments, the system can include an audio embedding generator configured to transform variable length audio into the dense audio embedding. The dense audio embedding can comprise a multidimensional audio embedding and audio embedding generator comprises a convolutional neural network with statistical pooling adapted for telephony signals. The multidimensional audio embedding can comprise a high-dimensional audio embedding. In an embodiment, the audio embedding generator comprises an automatic speech recognition (ASR) system that includes a Whisper model.

In some embodiments: the activator can be configured to perform a TopK operation that selects K latent indices of the latent vector v to be active for a given input; the audio embedding decoder (AED) can comprise a logistic regression classifier trained on labeled latent activations to identify the latent index; the target attribute can comprise spoken language and the monosemantic latent feature corresponds to a target language; the target attribute can comprise music only audio, and the monosemantic latent feature can correspond to interactive voice response (IVR) hold music; increasing latent dimensionality can cause the monosemantic latent feature to split into subfeatures corresponding to different subpopulations; the relative similarity score can be computed as a difference of cosine similarities to reference centroids computed from the reconstructed embedding ϵ for labeled datasets; the audio embedding decoder (AED) can be configured to apply adaptive thresholding to similarity scores to reduce false accepts and false rejects; the target attribute can be for language-aware routing and the identification data is transmitted to the computing device in a telephony pipeline and pre-ASR language gating to reduce computation and error rates; and/or the system can be deployable on-device, at an edge, or in a cloud, and is model-agnostic with respect to audio-embedding pipelines.

According to a further aspect of the disclosure, a method is provided for extracting and steering audio features in audio embeddings to analyze audio. The method comprises: receiving a dense audio embedding representing the audio; encoding the audio embedding to an expanded latent vector; applying an activation operation to the expanded latent vector to obtain a sparse latent vector; decoding the sparse latent vector to generate a reconstructed embedding; analyzing the reconstructed embedding to identify at least one of (i) a source of the audio, (ii) one or more characteristics of the audio, and (iii) one or more characteristics of the source of the audio; and outputting identification data to a computing device, wherein the identification data comprises at least one of (i) the source of the audio, (ii) the one or more characteristics of the audio, and (iii) the one or more characteristics of the source of the audio.

The method can include: identifying a monosemantic latent index by training an audio embedding decoder (AED) classifier over latent activations and selecting a top ranked index; and steering the reconstructed embedding by altering an activation value at the monosemantic latent index to change a relative similarity score between the reconstructed embedding and reference centroids of different classes; routing the identification data to the computing device, wherein the routing includes language-aware routing based on the target attribute; transforming the audio into the dense audio embedding, wherein the dense audio embedding comprises a high-dimensional audio embedding; and/or applying the activation operation comprises performing a TopK operation that selects K latent indices of the latent vector to be active for a given input. In an embodiment, the dense audio embedding is received from an automatic speech recognition (ASR) system comprising a Whisper model.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced.

FIG. 1 shows a block diagram of an embodiment of an audio processor unit (APU).

FIG. 2 shows a block diagram of an embodiment of an autoencoder.

FIG. 3 illustrates an example of an audio processing process performed by an embodiment of an APU.

FIG. 4 shows an embodiment of a sparse autoencoder included in the APU of FIG. 1.

FIG. 5 shows a nonlimiting example of the performance of a top latent index for classifying language across a plurality of models in an APU with varying latent dimension and TopK activation, including the appropriate latent index in the task of Spanish language identification.

FIG. 6 shows a nonlimiting example of the performance of a top latent index for classifying music across a plurality of APU with varying latent dimension and TopK activation.

FIG. 7 shows a nonlimiting example of splitting of a Spanish feature as a latent space grows.

FIG. 8 shows a nonlimiting example of a distribution of relative similarity scores computed before and after feature steering for Spanish and English samples.

FIG. 9 shows results in which an example of distributions of relative similarity scores before and after music feature steering are shown.

FIG. 10 shows an example of a confusion matrix created using a predictor in an example.

FIG. 11 shows an example of a confusion matrix showing three languages and the predictions based on latent index 5106.

FIG. 12 shows three examples of the positional latent indexes, all of which are tightly located temporally.

FIG. 13 shows an example of a latent representing the diphone R UW1.

FIG. 14 shows an example of a set of features that an autoencoder uncovered.

FIG. 15 shows an example that demonstrates words which have the largest ratio of activated frames for latent index 29 in an example.

The present disclosure is further described in the detailed description that follows.

### DETAILED DESCRIPTION OF THE DISCLOSURE

The disclosure and its various features and advantageous details are explained more fully with reference to the non-limiting embodiments and examples that are described or illustrated in the accompanying drawings and detailed in the following description. It should be noted that features illustrated in the drawings are not necessarily drawn to scale, and features of one embodiment can be employed with other embodiments as those skilled in the art would recognize, even if not explicitly stated. Descriptions of well-known components and processing techniques may be omitted so as to not unnecessarily obscure the embodiments of the disclosure. The examples are intended merely to facilitate an understanding of ways in which the disclosure can be practiced and to further enable those skilled in the art to practice the embodiments of the disclosure. Accordingly, the examples and embodiments should not be construed as limiting the scope of the disclosure. Moreover, it is noted that reference numerals represent similar parts throughout the several views of the drawings.

Recent advances in explainable machine learning have highlighted the potential of sparse autoencoders in uncovering monosemantic features in densely encoded embeddings. While most research has focused on text-based large language model (LLM) embeddings, the applicability of this technique to other domains remains largely unexplored.

There has been significant work to improve the interpretability of neural network models. Local Interpretable Model-agnostic Explanations (LIME)-based solutions have examined the output of models to better understand what they're acting upon but have not investigated how those decisions are being made. Other solutions have examined how model weights work for image recognition and other tasks where reconstructed input data can be estimated or otherwise interpreted, however few of these solutions have been applied to audio data.

For instance, in one solution, classification tasks were trained as a first stage, and then the speaker verification task was trained on the output of the first stage. In this case, the model was constrained to only act on the attributes manually selected by the researcher. An issue with audio is the very nature of the data (for example, high dimensionality and temporal variability), which it makes it difficult to visualize and understand small variations.

There have been attempts to improve interpretability for speaker recognition models. For instance, speaker embeddings have been used to perform additional classification tasks. Such implementations have demonstrated whether a model has sufficient information to make various classifications but have not shown that the information is necessarily useful or effective for speaker recognition.

Recently, studies have utilized sparse autoencoders (SAEs) to examine data embedded within tokens utilized in large language models (LLMs). Since the SAEs act directly on embedded data, any given hidden layer output can be examined. As described herein, SAEs can be utilized to uncover features in densely encoded vectors successfully. Most research in this area has focused on embeddings generated from large language models, showing effective monosemantic feature extraction. However, many complex neural network models also generate embedded data prior to delivering the desired target. In principle, the same SAE technique can be applied to many different forms of models and the embeddings they produce (such as audio foundational models). Explainable machine learning models are critical to understanding what the model is acting on to make predictions. When minor perturbations can result in different predictions, this indicates that deep neural networks may be acting on undesirable inputs. Insight into the embedded data created by these models would help alleviate some of their black box nature and allow a better understanding of how features are being interpreted by a given model.

The instant disclosure provides a solution that disentangles and interprets latent attributes within audio embeddings and that steers attributes to analyze and control model behavior. The solution includes systems and methods configured to provide interpretable control over dense audio embeddings and enable mechanisms to analyze, diagnose, and adjust model behavior in production audio systems. The systems and methods of the disclosure are configured to make audio processing and recognition systems more transparent and controllable.

In various embodiments, the systems and methods of the instant disclosure are configured to: apply sparse autoencoders (SAEs) to audio embeddings generated from machine learning models, such as, for example, Titanet, Whisper ASR, Parakeet ASR, ECAPA-TDNN, WavLM, PyAnnote, ECAPA++, ECAPA2; extract monosemantic features from non-textual embedded data; identify and manipulate, by one or more SAEs, features such as language and music that are not evident in the original embedding; and provide interpretable embedded data, for example, for audio processing or audio-based recognition, including speaker recognition.

In some embodiments, the systems and methods include one or more audio embedding models that can be built and trained to encode audio data (including, for example, audio-based speaker data) into embeddings that represent audio characteristics. The embeddings can be analyzed through the latent space of an SAE and audio features (for example, monosemantic features) extracted from the audio data. In this regard, the elements of the latent space can be monosemantic, meaning that their activation corresponds to a singular meaningful characteristic of the original audio signal. The systems and methods can include one or more SAEs, for example, as non-transformer-based models, to extract audio features, including for example monosemantic features from audio-based speaker data, including feature splitting and feature steering.

In various embodiments, the systems and methods of the disclosure can be configured for language-aware processing and/or routing. In some embodiments, including for applications such as, for example, call centers and customer experience (CX) operations, the systems and methods are configured to automatically detect a caller's spoken language from existing audio embeddings and route a call to a node (for example, an Internet Protocol (IP) address, a Media Access Control (MAC) address, a port number, or other node identifier) of an agent associated with the spoken language, such as, for example, a communication device of a call center agent or an interactive voice response (IVR) agent, with or without an automatic speech recognition (ASR) transcript. The systems and methods can be configured to identify music-only segments to suppress unnecessary processing, such as, for example, transcription or billing during non-speech periods, and improve analytics on real speaking time. The systems and methods can be configured for quality assurance and pinpoint segments with code-switching or accented speech to review recognition performance and agent handling.

In some embodiments, including, for example, for audio verification and security applications, the systems and methods can be configured to reveal the latent features (for example, channel conditions, language, or background music) that may be driving verification decisions, and detect undesirable sensitivities that can increase false accepts/false rejects. The systems and methods can be configured with adaptive thresholding and steer or attenuate features known to bias verification scores (for example, deactivate a latent music feature) before computing similarity and stabilizing performance.

In some embodiments, including, for example, for multilingual automatic speech recognition (ASR) and analytics pipelines, the systems and methods can be configured with pre-ASR language gating, in which monosemantic language features are used to select the appropriate ASR model to reduce computation and error rates. The systems and methods can be configured with domain-aware preprocessing, in which non-speech (music/noise) segments are automatically flagged to avoid contaminating downstream sentiment, topic, or compliance analytics.

In some embodiments, including, for example, for multilingual or monolingual ASR and analytics pipelines, the systems and methods can be configured to apply a discovered latent index in the appropriate processing logic, such as, for example, business processing logic. As an example, a latent index corresponding to detecting profanity can be used to analyze and identify certain sounds (for example, words) and, based on the identified sound, process the audio data by, for example, modifying one or portions of the data, routing the audio data to a particular node, rendering the audio data on a device (for example, display or speaker), or handling the audio data (or the media containing the data) in a predetermined manner based on the identified audio features. For example, sounds in the audio data can be analyzed to identify profanities or other spoken words and processes those sounds by, for example, redacting the identified profanities in a generated transcript, or by removing the profanity and replacing it with an innocuous equivalent sound or word. As a further example, a latent index corresponding to recognizing spoken numbers can be used to detect surrounding context and improve the generated transcript by replacing homophones with actual numbers (“too” versus “two”, “for” versus “four”).

In some embodiments, including, for example, for compliance, privacy, and risk controls, the systems and methods can be configured to provide interpretable, auditable features linked to model decisions (for example, why a call was routed or flagged), to support compliance reviews and customer disclosures. The systems and methods can be configured for sensitive attribute mitigation, including diagnosing and controlling how demographic-adjacent features (for example, gender proxies) emerge or split in embeddings, and documenting safeguards and steering policies.

In some embodiments, including, for example, for machine learning model monitoring and artificial intelligence for information technology operations (AIOps), the systems and methods can be configured to provide early warning for distribution shifts, including tracking activation patterns of audio features (for example, monosemantic features such as sudden rise in music feature on a new IVR) and triggering operational alerts. The systems and methods can be configured for feature-level service level agreements and policies (SLAs), including monitoring precision/recall for specific latent features as production key performance indicators (KPIs) and enabling targeted retraining when a feature drifts.

In some embodiments, including, for example, for personalization and end user experience applications, the systems and methods can be configured for context-aware prompts, including tailored IVR prompts or agent scripts based on detected language or environment (for example, quiet vs. music-heavy). The systems and methods can be configured to adapt in real-time and dynamically steer embeddings (for example, dampen background-music influence) to stabilize similarity scoring and improve recommendations or routing.

The systems and methods provided by the disclosure have significant and notable benefits and advantages compared to SOTA technologies. In some embodiments, the system and methods transform opaque audio embeddings into human-understandable latent factors (for example, language, music) and enable transparent diagnostics and decision trails and selectively activate/deactivate latent indices to control reconstructed embeddings and quantify impact via relative similarity metrics, thereby turning black-box vectors into tunable signals. The systems and methods identify when non-speech artifacts (for example, music/noise) or language shifts unduly influence verification or routing and steer the artifacts/shifts down to stabilize outcomes and detect languages at the embedding level and reduce ASR errors and wasted computation by selecting an applicable downstream machine learning model. The systems and methods can skip significant processing on music-only segments and routing calls correctly the first time, thereby lowering transfers and handle time.

In various embodiments, the systems and methods apply lightweight classifiers over latent vectors that provide high attribution quality without large labeled datasets or complex retraining. The systems and methods also apply model-agnostic layers that work with existing audio-embedding pipelines such as, for example, Titanet-style models, and can be deployed on-device, at the edge, or in the cloud. To provide an expandable taxonomy, as latent dimensionality grows, the systems and methods split features into finer subfeatures (for example, Spanish male/female) to enable granular control when needed.

In certain embodiments, the systems and methods facilitate auditability, including providing documentable, explainable latent features to support audits, internal risk controls, and regulatory inquiries; and/or enabling policy enforcement, including codifying steering rules (for example, muting music feature before similarity scoring) as consistent governance controls across platforms.

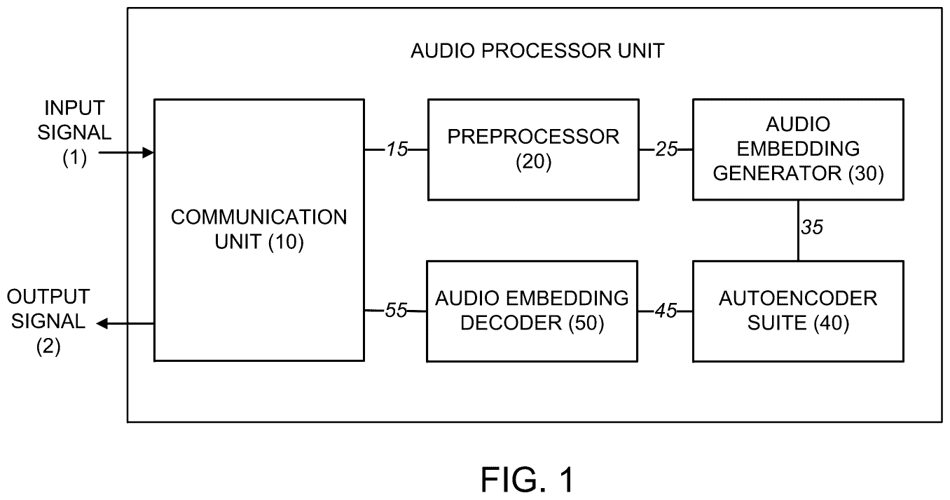

FIG. 1 shows a nonlimiting embodiment of an audio processor unit (APU), constructed according to the principles of the disclosure. The APU includes a communication unit 10, a preprocessor 20, an audio embedding (AE) generator 30, an autoencoder suite 40, and an audio embedding decoder (AED) 50. The APU is configured to receive an input signal 1 and transmit an output signal 2. The APU can be configured to receive the audio signal 1 from an external source (not shown), such as, for example, a microphone, a mobile phone, or a communication device and transmit the output signal 2 to a communication device (not shown). The audio signal can include audio data such as, for example, audio-based speaker data.

In various embodiments, the APU is provided as a self-contained device. Although not shown in FIG. 1, the APU includes a processor (for example, central processing unit (CPU) or graphical processing unit (GPU)), a memory, a plurality of input/output interfaces, multiple communication ports, and graphics and network capabilities. In some embodiments, the APU is provided as a computer-on-a-chip, system-on-chip (SoC), or a single-board computer. The components 20 to 50 can be provided as separate devices, modules, or combinations of devices and modules. In at least one embodiment, the components 20 to 50 are provided as modules comprising computer-executable instructions or code that are accessible and/or executable by the processor, which can include multiple processors.

In some embodiments, the APU is configured to receive the input signal 1 containing audio data, parse and process the audio data, analyze the processed audio data by one or more machine learning models, and identify one or more features of the audio data, including the source that originated the audio data, such as, for example, the person whose speaker data was included in the audio data. The APU is configured to further process the audio data based on the one or more audio features, which can include any one or more of editing, mixing, encrypting/decrypting, recording, transcribing, routing, or other handling or processing of the audio data and/or the input signal 1.

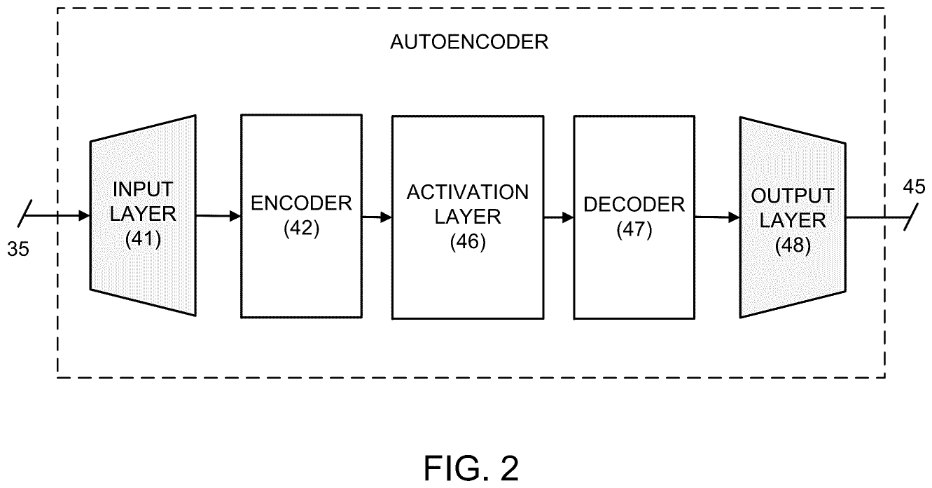

In certain embodiments, a machine learning model can include an encoder included in the AE generator 30 (such as, for example, a Titanet encoder and/or a Whisper encoder) and a decoder included in the AED 50 (such as, for example, a Titanet decoder and/or Whisper decoder), with the autoencoder (for example, shown in FIG. 2) being positioned between the model encoder and the model decoder.

The communication unit 10 includes one or more transmitters, one or more receivers, an input/output interface, one or more network interfaces, and a plurality of communication ports, including, for example, USB-A ports, USB-C ports, USB 4 ports, HDMI ports, DisplayPorts, and Thunderbolt ports. In various embodiments, the communication unit 10 includes a signal conditioner configured to operate on the input signals 1 and output a conditioned signal 15 that is in a suitable and protected format for the preprocessor 20. The signal conditioner can include, for example, any one or more of analog-to-digital converters (ADCs), an anti-alias filter, lowpass filter, bandpass filter, high-pass filter, amplifier, attenuator, or other signal conditioners capable of conditioning the input signal 1, including audio data, to output the signal 15 suitable for the preprocessor 20. The conditioned signal 15 can include a variable-length audio signal sampled at, for example, 16 kHz.

The preprocessor 20 includes, in various embodiments, one or more components, including, for example, a resampler, bandpass filter, denoiser, normalizer, and segmenter. The preprocessor 20 can apply noise reduction, filtering, and segmentation to the conditioned signal 15. In some embodiments, the preprocessor 20 is configured to receive the conditioned signal 15 as a variable-length audio signal and convert the raw audio data (or audio waveform) into acoustic features. The preprocessor 20 can include a converter configured to convert the one-dimensional audio data to multidimensional (for example, two-dimensional or 2D) audio data (for example, 2D audio frames) suitable for processing by the AE generator 30. The output of the preprocessor 20, including converted audio data 25 is sent to an input of the AE generator 30. The converted audio data 25 can include, for example, spectrograms or Mel-Frequency Cepstral Coefficients (MFCCs).

In an embodiment, the preprocessor 20 is configured to: filter out noise and other unwanted sounds; standardize an audio sample rate to ensure a consistent format for the AE generator 30; divide the audio data into fixed-length audio data segments; extract features from the audio data; and output the extracted features, which include MFCCs, to the AE generator 30.

In various embodiments, the AE generator 30 includes a machine learning platform comprising one or more machine learning models, including, for example, Titanet, Whisper ASR, Parakeet ASR, ECAPA-TDNN, WavLM, PyAnnote, ECAPA++, ECAPA2, and/or other neural network or machine learning architecture that extracts audio representations and/or generates audio embeddings, such as for purposes of audio analysis, audio processing, audio recognition, speaker recognition, speaker verification, or diarization tasks. The AE generator 30 is configured to receive and analyze the converted audio data 25 and generate audio embeddings 35. In the embodiments comprising a Titanet or Whisper model, the AE generator 30 analyzes the MFCCs (or acoustic features) in the converted audio data 25, aggregates variable-length features into fixed-length vectors, and outputs fixed-size representations (for example, 192-dimensional audio embedding) of a speaker's unique voice characteristics (t-vectors) as the audio embeddings 35.

The autoencoder suite 40 includes a plurality of autoencoders, including at least one sparse autoencoder (SAE). At least one autoencoder in the autoencoder suite 40 is configured to receive the audio embeddings 35 and disentangle features from the embeddings. The autoencoder is further configured to selectively steer features in the embeddings to generate and output reconstructed embeddings 45 to the AED 50. FIG. 2 shows a nonlimiting embodiment of one or more autoencoders included in the autoencoder suite 40. In this embodiment, the autoencoder includes an input layer 41, an encoder 42, an activation layer (or activator) 46, a decoder 47, and an outer layer 48. The input layer 41 is configured to receive the audio embeddings 35 and forward the embeddings to the encoder 42, which then transforms the embeddings to a higher-dimensional representation and outputs target (for example, the SAE) latent features. The target (for example, SAE) latent features are input to the activation 46, which enables learning of meaningful or specialized features, enforces sparsity by activating only a small subset of neurons in the layer per input, encouraging small activations to become zero and having only a few neurons in the layer activate per input (sparse code). In the case of an SAE, sparsity is enforced using KL-divergence or L1 regularization, as understood by those skilled in the art. The decoder 47 receives the output of the activation 46 and generates reconstructions 45 of the embeddings 35, while minimizing reconstruction loss.

Referring to FIG. 1, the AED 50, which can include a classifier, is configured to analyze the reconstructed embeddings 45 and identify audio features, including an audio source (for example, a speaker) or a characteristic of the source, of the original audio data—for example, the audio data that was included in the received input signal 1. In some embodiments, the AED 50 is configured to compare the reconstructed embeddings to a database of known sounds, speakers, and/or other embeddings using metrics such as cosine similarity. In the case of cosine similarity, the AED 50 can be configured to identify audio features (including audio sources) by comparing the reconstructed embeddings to audio-specific centroids, where the centroid is computed as a median embedding of labeled exemplars. Cosine similarity is calculated between reconstructed embedding and the centroid, and similarity scores are softmaxed to produce a confidence score, and reconstructed embeddings that exceed a threshold score are classified as positive detections of audio features (including audio sources).

The AED 50 can be configured to predict one or more features (including, for example, a source) of the audio data and output the prediction as AED output data 55. The AED output data 55 can be transmitted by the communication unit 10 as the output signal 2 to one or more communication devices (not shown). At the communication device(s) (not shown), the AED output data can be rendered by an output device (not shown) such as, for example, a display and/or speaker, to identify one or more sounds or other features in the original audio, including the source associated with the audio data. In some embodiments, the AED output data can include fraudster identification data, which can indicate whether the source is a known or predicted fraudster.

In other embodiments, the AED 50 can be configured to predict one or more features of the audio data and generate AED output data 55 comprising a transcript generated from the reconstructed embeddings. In generating the transcript in the AED output data 55, the AED 55 can recognize certain audio features (for example, words or sounds) and redact, remove, or otherwise modify the transcript based on the recognized audio feature, including, for example, redacting profanity, replacing words or sounds with similar or equivalent words or sounds, or otherwise modifying the transcript.

### Example 1

In a nonlimiting example, the performance of sparse autoencoder (SAE) models included in the autoencoder suite 40 were investigated to determine whether they can effectively extract monosemantic features from non-textual embeddings, specifically audio embeddings generated by a fine-tuned Titanet model. The investigation focused on three core aspects: feature identification; feature splitting; and feature steering. In the example, speaker biometric data was chosen, which is quite distinct from large language model (LLM) embeddings. This type of embedding is interesting because the data it represents is continuous and the embeddings are generated in an entirely different manner than those of an LLM.

In the example, to investigate performance of the SAEs with respect to monosemantic features, several steps were taken. First, a large set of speaker characteristic embeddings were generated by Titanet models. These embeddings were then used to train a series of SAEs, for example, in the autoencoder suite 40. Using these autoencoders, the speaker embeddings were transformed into sparse latent spaces. The characteristics and behaviors of these latent spaces were then investigated and observed to exhibit interpretable monosemantic features, such as language and music, which were not evident in the original embeddings. These features could be identified through logistic regression on latent activations and demonstrated properties like feature splitting as latent dimensionality increased, and feature steering, where manipulating a single latent element shifted reconstructed embeddings toward or away from specific characteristics.

### Feature Identification

In the example, using logistic regression on latent activations, latent indices were identified as being strongly correlated with specific attributes, including language (for example, Spanish vs. English) and music vs. voice, which were not obvious in the original dense embeddings, highlighting the interpretability advantage of SAEs. Regarding language, a single latent index was able to discriminate Spanish speech with high precision (up to 99.2%) and recall (95.5%) when using a model with latent dimension=200 and TopK=20. Regarding music vs. voice, another latent index achieved precision of 92.3% and recall of 99.1% for detecting IVR hold music.

### Feature Splitting

In the example, as latent dimensionality increased, certain features split into more granular representations. For example, the Spanish language feature initially appeared as a single latent element but later split into Spanish male and Spanish female features at higher latent dimensions (≈300). This behavior mirrored findings in LLM-based SAE studies, suggesting similar dynamics across domains.

In the example, identified latent features were manipulated to observe their effect on reconstructed embeddings—that is, feature steering. Activating the Spanish latent feature for English samples shifted embeddings toward Spanish similarity, while deactivating it for Spanish samples shifted them toward English. Similar steering was observed for music vs. voice embeddings.

### Feature Steering

In the example, identified latent features were manipulated to observe their effect on reconstructed embeddings—that is, feature steering. For language steering, activating the Spanish latent feature for English samples shifted embeddings toward Spanish similarity, while deactivating it for Spanish samples shifted them toward English. Similar steering was observed for music vs. voice embeddings.

In the example, SAEs were discovered to uncover interpretable, monosemantic features hidden in dense embeddings. These features exhibited properties such as feature splitting with increased latent dimensionality and feature steering that enabled controlled manipulation of embeddings. Based on the investigation, it was discovered that SAEs included in the autoencoder suite 40 are a powerful tool for explainable artificial intelligence in diverse domains.

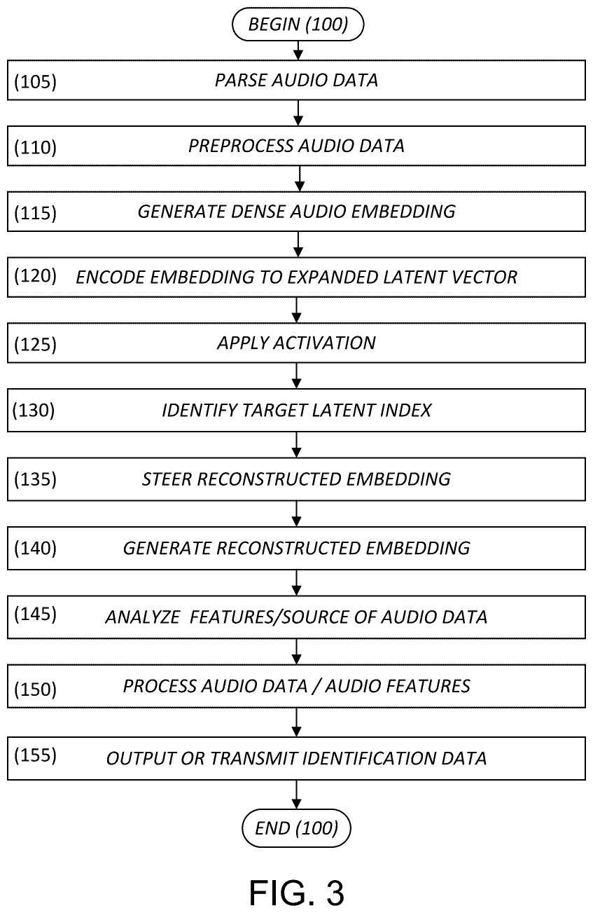

FIG. 3 illustrates an example of an audio processing process 100 performed by an embodiment of the APU (for example, shown in FIG. 1). Referring to FIGS. 1, 2, and 3 together, after the input signal 1 is received by the communication unit 10 and the audio data parsed from the signal (Step 105), the audio data is processed by the preprocessor 20 to convert the audio data to a format suitable for ingestion and processing by the AE generator 30 (Step 110). The AE generator 30 operates on the converted audio data to generate dense or high-dimension (for example, 192-dimension) audio embeddings (Step 115).

The dense audio embeddings are received by one or more autoencoders in the autoencoder suite 40, which encode (for example, by the encoder 42, shown in FIG. 2) the embeddings to expanded latent vectors (Step 120). An activation process, such as, for example, TopK sparsity activation and/or L1 regularization, is applied (for example, by the activation layer 46, shown in FIG. 2) to the expanded latent vectors to obtain sparse latent vectors (Step 125).

The sparse latent vectors are analyzed (for example, by the processor or in the activation layer 46) to identify one or more target (for example, monosemantic) latent indexes over latent activations and select the top ranked index(es) (Step 130). In various embodiments, the one or more target latent indexes comprise monosemantic latent indexes. The reconstructed embeddings can be steered (for example, by the processor, activation layer 46, and/or AED 50) by altering an activation value at the target (for example, monosemantic) latent index(es) to change a relative similarity score between the reconstructed embeddings and reference centroids of different classes (Step 135). The steered sparse latent vectors are decoded (for example, by the decoder 47) to generate reconstructed (or reconstruct) embeddings (Step 140).

The reconstructed embeddings are analyzed by the AED 50 and one or more audio features predicted, including, for example, the source that originated the original audio data, as well as one or more characteristics of the original audio data (Step 145), which in the case of human speakers can include spoken words, uttered sounds, a speaker's identity, one or more speech attributes or characteristics, and/or whether the speaker was previously identified, such as, for example, in fraudster detection applications. The predicted features are included in the AED output 55 (shown in FIG. 1).

The process 100 can include audio-based processing of the audio data, predicted features, and/or the input signal by the APU (for example, by the processor) (Step 150). In some embodiments, the audio-based processing includes language-aware routing of the audio data, predicted features, and/or input signal to a particular communication device based on target attributes (Step 150), such as, for example, in a telephony pipeline with pre-ASR language gating to reduce computation and error rates. In some embodiments, the audio-based processing includes generating transcriptions (for example, by an automatic speech recognition system) from reconstructed embeddings (Step 150), in which certain words or sounds can be redacted, modified, or replaced with similar words or sounds, as discussed above. In an embodiment, the audio embedding generator 30 can include an automatic speech recognition (ASR) system, which can be configured to generate transcripts.

The AED output data 55 can then be output or sent to a computing device or a communication device (not shown) (Step 155). In some embodiments, AED output data containing generated transcripts and/or audio feature data, such as, for example, audio source identification data, can be rendered on an output device such as a display and/or speaker.

In various embodiments of the process 100, the embeddings (for example, Step 115 in FIG. 3) are generated by a fine-tuned Titanet model that uses convolution layers and statistical pooling to transform utterances of variable length into a high-element vector (for example, 192-dimension vector) as a representation of the audio's characteristics. These vectors, also known as embeddings, are dense and not clearly interpretable. Since they are suitable for audio analysis, identification, and processing (for example, audio recognition), but characteristics like language, pitch, and gender are nonobvious in the embeddings, the Titanet modes are fine-tuned using a NeMo framework to create a telephony-adapted variant. The resultant model is included in the AE generator 30 (shown in FIG. 1) and achieves a sub 1% EER in the telephony domain.

In some embodiments of the process 100, one or more SAEs in the autoencoder suite 40 are used to disentangle features from the Titanet embeddings output from the AE generator 30 (shown in FIG. 1). The SAE(s) transforms the dense embeddings (for example, 192-element vector) into a latent space (Step 120) and then back into a reconstruction of the original feature (Step 130). The SAE(s) can be trained used mean squared error used to drive reconstruction accuracy and ensure that the autoencoder has learned the relationships within the data.

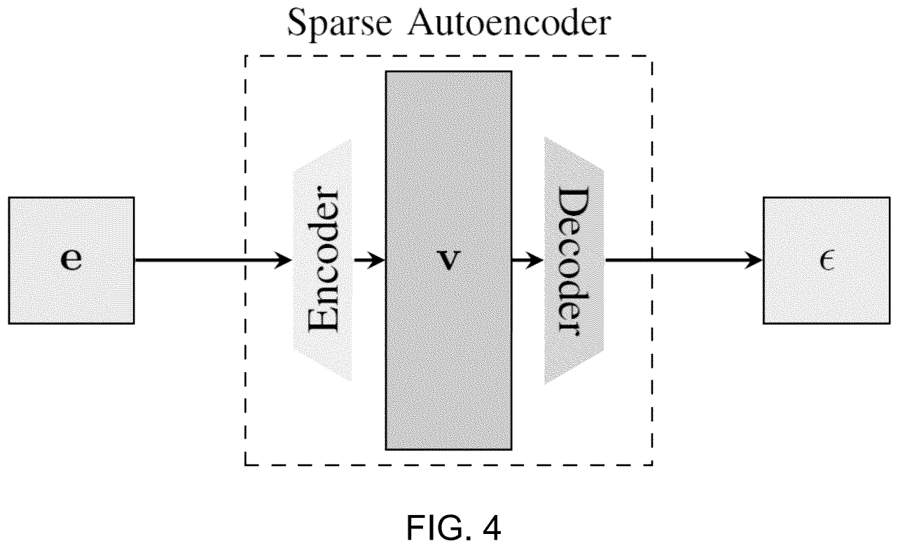

While the latent space in a typical autoencoder is smaller than the original feature space, for the SAEs included in the autoencoder suite 40, the inverse is performed for the dimensionality of the latent space expanded to many times the original feature size. The general layout of an SAE included in an embodiment of the autoencoder suite 40 is shown in FIG. 4.

FIG. 4 shows a nonlimiting embodiment of a sparse autoencoder included in the autoencoder suite 40. In this embodiment, the embedding e (for example, embedding 35, shown in FIG. 1) is reconstructed as a reconstructed embedding ϵ (for example, reconstructed embedding 45, shown in FIG. 1) via the latent vector ν.

It is important to note that without additional constraints a naive autoencoder with a latent dimension greater than or equal to the feature space might simply act as a pass-through for the feature data. In order to enforce sparsity and reduce any pass-through effect, an activation process such as, for example, TopK activation and/or L1 regularization, is applied to the expanded latent vector.

For instance, in an embodiment, the activation process includes L1 regularization alongside a ReLU activation function to reduce the total activations of the latent layer (for example, hidden layer 46 in FIG. 2, or latent vector ν in FIG. 4) and to drop non-critical latent elements during the course of training the SAE(s) in the autoencoder suite 40 (shown in FIG. 2). Because this process can, in certain applications, have a significant issue with “dead latents” or elements of the latent layer that never activate once the model is trained, another process, such as, for example, a TopK activation process can be used.

In some embodiments, the TopK process is used after the encoding layer (for example, encoder 42 shown in FIG. 2 or encoder shown in FIG. 4) to reduce the dead latents effect significantly. In certain embodiments, SAE models with different combinations of activations and latent dimension are trained, with all the models demonstrating a stable validation mean squared error.

Referring to FIG. 4, the latent space of the SAE in this embodiment can be examined directly by examining samples that share a common latent activation and then listening to them to identify shared characteristics. This can, however, prove difficult in many instances since most of the latent elements might correspond to features that are completely non-obvious in the audio itself. To address this challenge, a dataset can be curated with the desired feature labeled (for example, manually) and then a logistic regression model can be trained on the latents to classify the feature. The weights of the logistic regression model can be used to identify which of the latents is most important for making a particular classification. The latent can then be used as a predictor for the desired feature and its performance can be evaluated on a withheld test set.

In some embodiments, attributes such as, for example, the language of the speaker and music-only audio can be selected for unambiguous labeling in telephony applications. In various cases music may be present in a dataset since hold music is often played during a given phone call. This music is never coincident with the caller's voice. In other embodiments, one or more additional attributes are selected for training and testing datasets for the autoencoders 40 (shown in FIG. 1), including any one or more physical attributes (for example, pitch, volume or loudness, prosody, rate or speed, tone, timbre or voice quality, articulation or clarity, fluency, and emotion), linguistic attributes (for example, vocabulary, grammar, syntax, pronunciation, semantics, and coherence), and paralinguistic attributes (for example, intonation, stress, emphasis, pauses, and rhythm).

In addition to discriminant accuracy, the effect of an identified latent feature can be demonstrated with feature steering, where the activation of the feature is artificially turned on or off to observe how the reconstructed audio embedding is impacted. For example, the similarities of a given audio embedding can be measured against reference Spanish and English embeddings before and after the activation of the latent feature identified as Spanish audio is manipulated.

Referring to the SAE model in FIG. 4, an input audio embedding is encoded, e∈ [symbol] , into a latent vector, ν∈ [symbol] , and subsequently the latent vector, ν, is decoded into a reconstructed audio embedding, ϵ∈ [symbol] , if the latent index φ∈[0, L−1] of the SAE model has been identified as the feature that signifies Spanish audio samples when activated, then the significance of this feature can be examined by deactivating it for the latent vector of a Spanish sample ν^{(S)}∈ [symbol] ^{L}, in the test set, with νₗ^{(S)} denoting element l∈[0, L−1] of ν^{(S)}:

$${\tilde{v}}_{ℓ}^{( S )} = \{ \begin{matrix}{v}_{ℓ}^{( S )} & if ℓ \neq ϕ \\ - {a}_{ϕ} & if ℓ = ϕ\end{matrix} \qquad ( 1 )$$

Conversely, feature φ can be artificially activated for the latent vector of an English sample in the test set ν^{(E)}:

$${\tilde{v}}_{ℓ}^{( E )} = \{ \begin{matrix}{v}_{ℓ}^{( E )} & if ℓ \neq ϕ \\ {a}_{ϕ} & if ℓ = ϕ\end{matrix} \qquad ( 2 )$$

where a_{φ}∈ [symbol] in Equations (1) and (2) is a pre-selected value for manually steering the latent feature φ. In at least one embodiment, a_{φ}=1.

The feature-steered audio embedding, \tilde{ϵ}, can be constructed by the SAE decoder using \tilde{v} from Equations (1) or (2) as input. In order to evaluate the difference between presteering ϵ and post-steering \tilde{ϵ}, their relative similarity scores are computed and compared:

$${δ}_{s} ( x ) = s ( x , {\hat{ϵ}}^{( S )} ) - s ( x , {\hat{ϵ}}^{( E )} ) \qquad ( 3 )$$

where x∈{ϵ, \tilde{ϵ}}. In Equation (3), \hat{ϵ}^{(S)} and \hat{ϵ}^{(E)} are the centroids of SAE-reconstructed Spanish and English embeddings in the training set, respectively, and s(x, \hat{ϵ}^{(S)}) denotes the cosine similarity score between x and \hat{ϵ}^{(S)}. Therefore, the relative similarity score δₛ(x) measures how much closer a audio embedding x is to the reference Spanish embedding \hat{ϵ}^{(S)} than to the reference English embedding \hat{ϵ}^{(E)}. A positive δₛ(x) indicates a greater similarity to Spanish, while a negative value suggests greater similarity to English. The comparison of presteering δₛ(ϵ) with post-steering ϵₛ(\tilde{ϵ}) provides a quantitative view of the latent feature significance.

While the Spanish latent feature is used as an example above, Equations 1 through 3 can be applied to all identified SAE latent features, with relative similarity score as a metric to measure the effectiveness of feature steering.

### Example 2

In another nonlimiting example, a dataset comprising a collection of phone calls to the customer support center was used. Music and automated announcements were occasionally captured, depending on the call. Embeddings were created, using an embodiment of the APU (for example, shown in FIG. 1), from 4-8-second long segments taken from the original call using a command-line utility, such as, for example, Sound exchange (SoX), to select non-silent sections of the audio. These audio segments were processed via a trained telephony-based Titanet model included in the AE generator 30 (shown in FIG. 1) to generate audio embeddings.

In this example, three distinct datasets were curated, including 1) an Autoencoder training dataset, 2) a Language Feature dataset, and 3) a Music Feature dataset. The Autoencoder training dataset consisted of approximately 1,100,000 Titanet embeddings from approximately 29,000 speakers, each with a dimension of 192. This data had no test sets as the autoencoders were trained in an unsupervised manner. The Language and Music Feature datasets were developed from a distinct set of audios that did not share the same speakers as the autoencoder training dataset.

In the example, a Whisper ASR model was used to predict the spoken language, which functioned as a loose label that was later manually verified, for the Language Feature dataset. At the time of annotation, perceived gender was also tagged. The resultant demographics for this dataset are shown in Table I below, which shows the distribution of the Language Feature dataset in the example; the test set had an even balance of 400 samples per language.

TABLE I

| | Latent Element Training | Test |
|---|---|---|
| English Female | 457 | 283 |
| English Male | 166 | 117 |
| Spanish Female | 382 | 279 |
| Spanish Male | 166 | 121 |

In the example, the Music Feature dataset was labeled using transcripts generated from Whisper to identify audios which had no voices. Since activity detection was performed, these audios were not silent, rather they contained either noise or music. The resultant dataset was manually examined to identify music. Other spoken audios segments were used for the voice class. The distribution of this dataset is shown in Table II below, which shows a distribution of the training and test data for the Music Feature dataset in the example.

TABLE II

| | Latent Element Training | Test |
|---|---|---|
| Music | 109 | 200 |
| Voice | 257 | 200 |

In some embodiments, simple SAE models are built comprising a simple linear layer with an activation layer as the encoder to the latent space. In these embodiments, the decoder is another linear layer back to the feature space. While the models can be trained with both ReLU and TopK activations, ReLU models show a significant issue with dead latents, where much of the latent space may never be active. Accordingly, TopK activation is used.

In the example, a grid search was performed with K values and latent dimension. Latent values between 100 and 1,200 were examined, with larger values being undertrained and omitted from the results. K values between 5 and 35 were also examined for TopK activation. Using the training set of the Language Feature dataset and a logistic regression model, an index was identified for each given autoencoder model in the autoencoder suite 40 that most effectively discriminated between Spanish and English voices. A non-zero activation value for the given latent index was treated as Spanish. The capability of the index as a predictor was highly dependent on the model parameters as examined in the grid search.

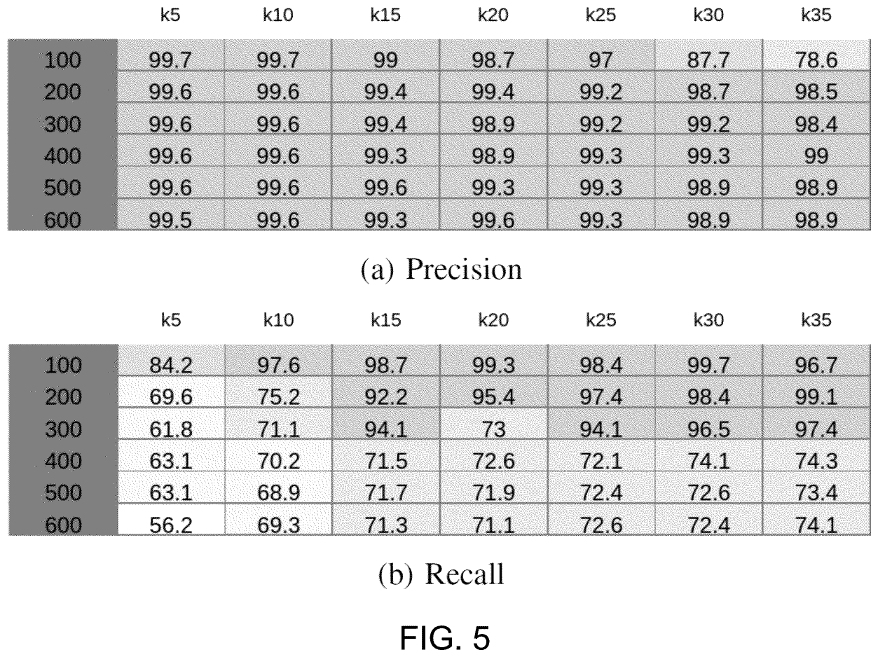

FIG. 5 shows the performance, in the example, of the top latent index for classifying language across the models in the autoencoder suite 40 with varying latent dimension and TopK activation, including the appropriate latent index in the task of Spanish language identification. As seen in table (a), the majority of the models had a recall that stabilized around 70%, however lower latent dimensions and higher K values led to recall values in the mid 90's, as seen in table (b) of FIG. 5.

Referring to FIG. 5, taking as an example the model with K=20 and latent dimension of 200, the latent index 15 functions as a discriminant with a precision of 99.2% and recall of 95.5%. Investigating the wrongly classified audios also leads to the discovery that 91.0% of the false positive samples appear to be native Spanish speakers speaking English with the remainder being other nonnative English speakers. The false negative set reveals the occasional presence of code-mixing, in this case the use of English words in Spanish speech.

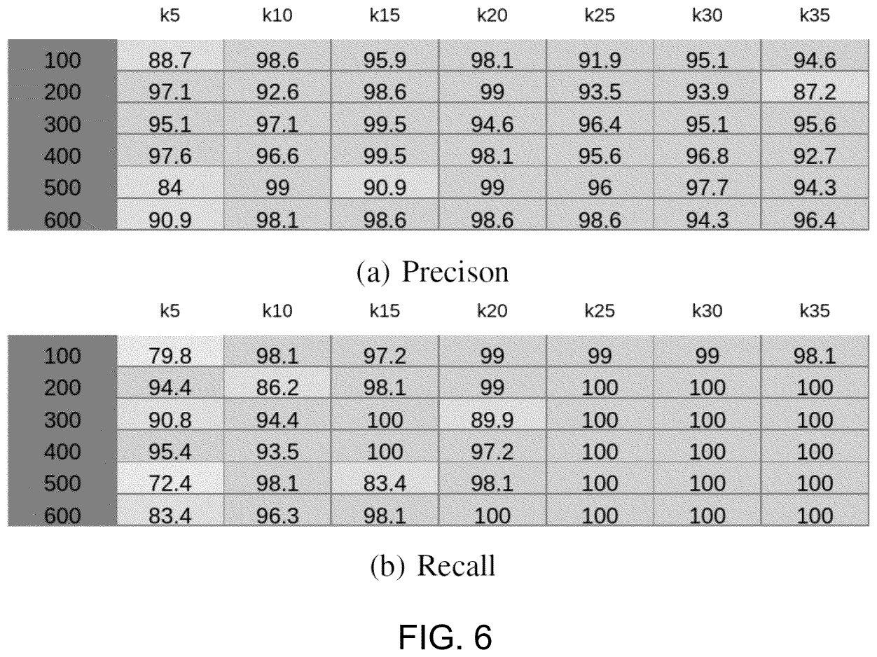

In the example, the training set of the Music Feature dataset was used to identify which element of the latent space was most significant in helping to identify the desired class, in this case hold music. The leading latent activation functioned as a high-quality discriminator for music, as seen in FIG. 6.

FIG. 6 shows the performance, in the example, of the top latent index for classifying music across models in the autoencoder 40 with varying latent dimension and TopK activation.

As seen in (b) of FIG. 5, in the example, it appeared that there were two distinct regimes of behavior. Further investigation revealed that these regimes were due to a splitting of the Spanish language feature. When examining the audios selected via the Spanish index in the lower recall model region, it was apparent that the majority of the male Spanish speakers had dropped out of the set.

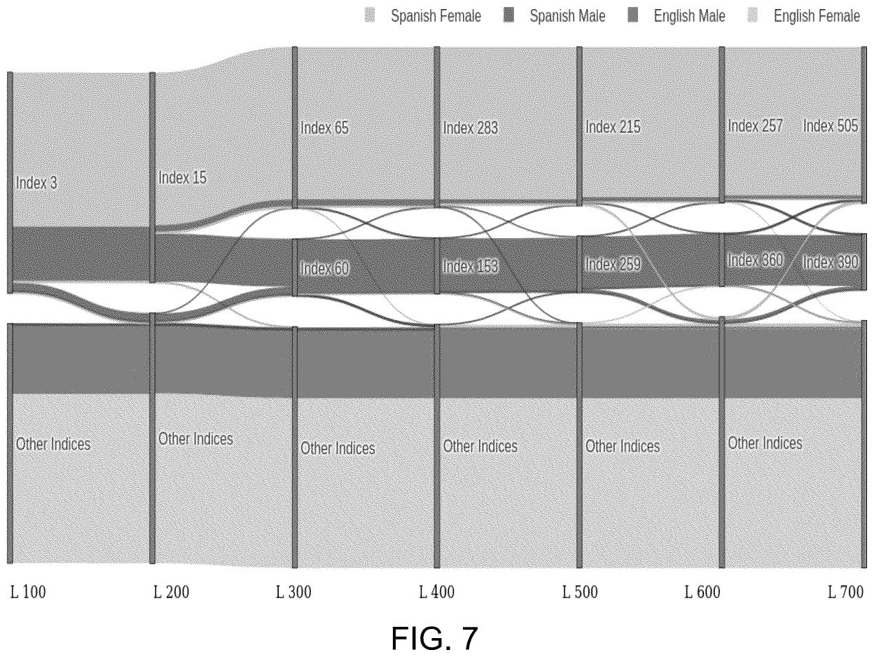

FIG. 7 illustrates the splitting of the Spanish feature as the latent space grows. As seen in FIG. 7, for latents 100 and 200 the indices 3 and 15, respectively, were the Spanish language latent elements. However, for higher latent dimensionality, the Spanish language was no longer encoded as a single element of the latent space. Instead, as seen in FIG. 7, the Spanish language feature split into a Spanish male feature with index 60 and a Spanish female feature with index 65 at a latent of 300. This same behavior repeated regardless of K value, however the latent dimensionality at which it occurred did vary.

Regarding table (b) in FIG. 5, it appears that as K grows, the latent dimensionality required to cause a split also grows, but only up to a point. After this point, which is around 300 elements, the behavior plateaus and the split remains around the same latent dimensionality.

As discussed above, in the SAE model with latent dimension of 200 and K=20, latent index 15 was identified as the feature for Spanish, with attribution precision of 99.2%. To examine its significance, feature steering was performed as discussed above, by deactivating the latent feature for Spanish samples and activating it for English samples in the Language Feature test set.

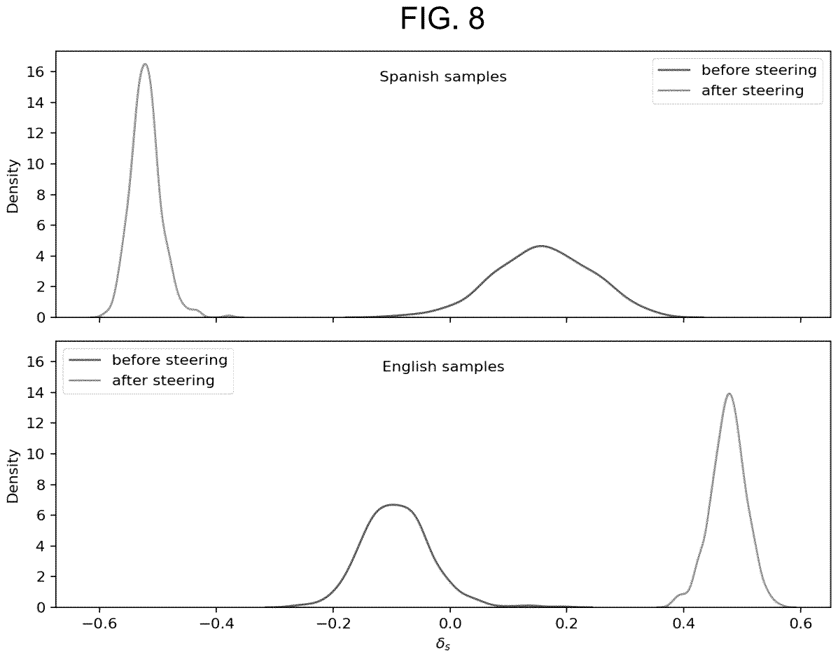

FIG. 8 shows a distribution, in the example, of relative similarity scores δₛ computed using Equation (3) before and after feature steering for Spanish and English samples. Since a positive δₛ signified the sample was more similar to the reference Spanish embedding than the reference English embedding, it was observed that when this latent feature was deactivated for Spanish samples in the test set, the re [symbol] (s)ing SAE-reconstructed embeddings shifted _{\hat{ϵ}}(E)n the reference Spanish embedding toward the reference English embedding. Conversely, when this latent feature was activated for English samples, the opposite shift occurred. Table III below lists the mean values of the relative similarity scores for Spanish and English samples before and after feature steering, with the change between positive and negative δₛ values.

TABLE III

| | Before Steering | After Steering |
|---|---|---|
| Spanish Samples | 0.160 | −0.520 |
| English Samples | −0.091 | 0.475 |

In the example, the findings discussed above, in which latent index 74 represented IVR music in the SAE model with latent dimension of 200 and K=20, feature steering was performed for music and voice samples in the Music Feature test set.

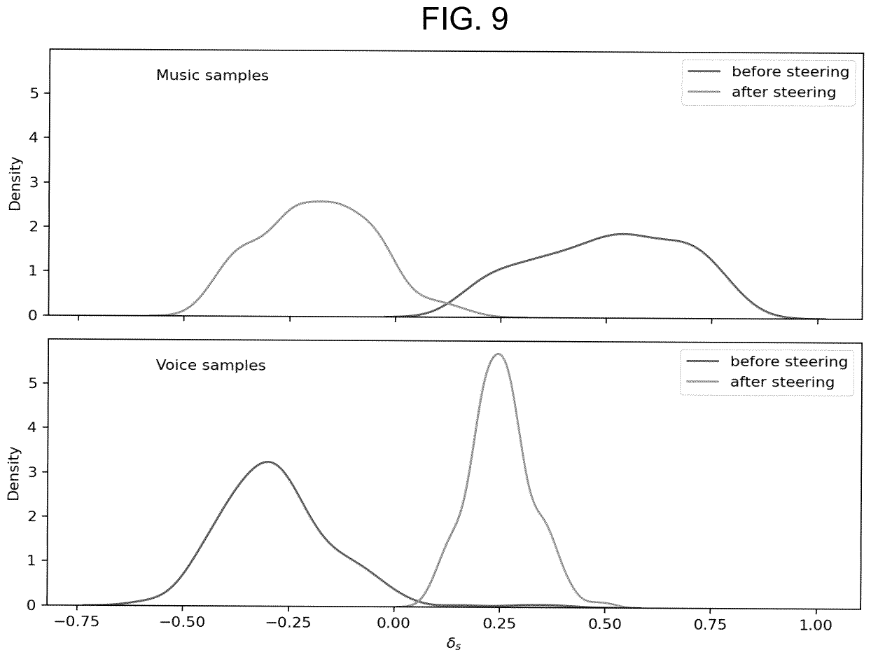

FIG. 9 shows the results, in which an example of distributions of relative similarity scores before and after music feature steering are shown. The results are also in Table IV below, which shows the mean values of the relative similarity scores for music feature steering.

As seen FIG. 9 and Table IV, the music sample embedding shifted from proximity to the reference music embedding to proximity to the reference voice embedding when its latent music feature was deactivated, and the voice sample embedding shifted in the opposite direction when its latent music feature was activated.

TABLE IV

| | Before Steering | After Steering |
|---|---|---|
| Music Samples | 0.505 | −0.185 |
| Voice Samples | −0.276 | 0.252 |

### Example 3

In another nonlimiting example, the AE generator 30 (shown in FIG. 1) includes a Whisper transformer-based ASR (Automatic Speech Recognizer) model, wherein the autoencoder suite 40 includes an autoencoder with a high-dimensional latent space trained on frame-level embedding extracted from the Whisper encoder. In this example, the Whisper model, which is capable of transcribing and translating spoken word in a wide variety of languages, was used to encode audio data. In some embodiments, the Whisper model is configured to transcribe and translate (input audio, output text) and comprises a Whisper encoder and decoder. In an embodiment, the AE generator 30 includes the Whisper encoder and the AED 50 includes Whisper decoder, with the SAE 40 located in between to modify the output transcript text. The AE generator 30 with the Whisper encoder was observed to learn a rich and diverse set of representations from audio input, including phonetic, semantic, morpho-logical, positional, and lexical features.

In this example, the autoencoder suite 40 includes the autoencoder shown in FIG. 2, which was connected immediately after the final layer of the Whisper encoder. Since the final layer of the Whisper encoder is directly ingested by the input layer 41 of the autoencoder, it potentially contains the most important information in order for the autoencoder to accurately transcribe the audio data. By analyzing each layer of the Whisper encoder, one could examine how information changes through the encoder.

In the example, the encoder 42 (shown in FIG. 2) included a simple linear encoder layer with a TopK activation and the decoder 47 included an another linear layer to reconstruct the Whisper embedding space. The autoencoder mapped the 512 width Whisper base encoding to a large hidden layer of 16000 elements and then back to the 512 elements. In order to constrain sparsity, the autoencoder was trained using a TopK activation to constrain the number of latents which can be activated, here set to 45. This created a total of 16.4 million trainable parameters. The autoencoder was trained using mean squared error (MSE) as the loss function between the input layer 41 and output layer 48 (shown in FIG. 2).

Since Whisper took an input of 30 seconds of audio, all audio files were padded or trimmed to 30 seconds by default. To avoid training the autoencoder 40 on padded frames, they were identified and removed during training. The final input data to the autoencoder 40 was specifically the individual frame-level Whisper embedding cut to the audio length. A given audio will generate up to 1500 frames (30 seconds worth) of training data. The data used to train the autoencoder 40 comprised several different datasets, since it was expected that data diversity is critical to help develop a diverse set of latent features. This dataset included LJSpeech, LibriSpeech, Voxceleb 1, Mozilla Common Voice English, SLR39, SLR67, SLR61 and SLR71-SLR75, and Musan. In total the dataset had 646, 769 files. Since the data points were the individual time frames from the Whisper encoder, there were on the order of 200 million data points which was sufficient to train the parameters of the autoencoder. Additional data was used in some analyses to evaluate the trained model, these datasets included ESC-50 and Mozilla Common Voice Spanish and French.

In this example, the autoencoder 40 modified the latent vector to a modified latent vector and decoded the modified latent vector to reconstruct the embedding. The modified encoding was then taken as input to the Whisper decoder to produce a modified transcript. This example demonstrated the powerful effect of the modified latent index (by the autoencoder 40) on the transcript.

The latent space was examined by utilizing the Whisper generated transcripts and correlating latent space activations. The classification of latents was accomplished by examining the shared traits across audio samples that were activated for the latent. Similarly, for each hypothesized classification, precision values were obtained to quantify how many of the activated audio samples contained the hypothesized feature. A number of interesting features were found to be present in the SAE latent space. It is noted that latent indexes exhibit complex behavior with both splitting and absorption. A latent associated with a feature may not be activated for all samples containing that feature. There may be other latents with more narrow feature characteristics.

Since noise information can sometimes appear in Whisper encoded data, noisy samples were sourced from ESC-50, which contained 50 distinct types of non-speech noise, and voiced and non-voiced samples were compared. The results demonstrated that the activation of latent index 15019 clearly discriminated the two classes. In the example, a predictor was created according to the following logic:

$$pred = \{ \begin{matrix}if {ℓ}_{15019} > 0 & noise \\ else & voice\end{matrix}$$

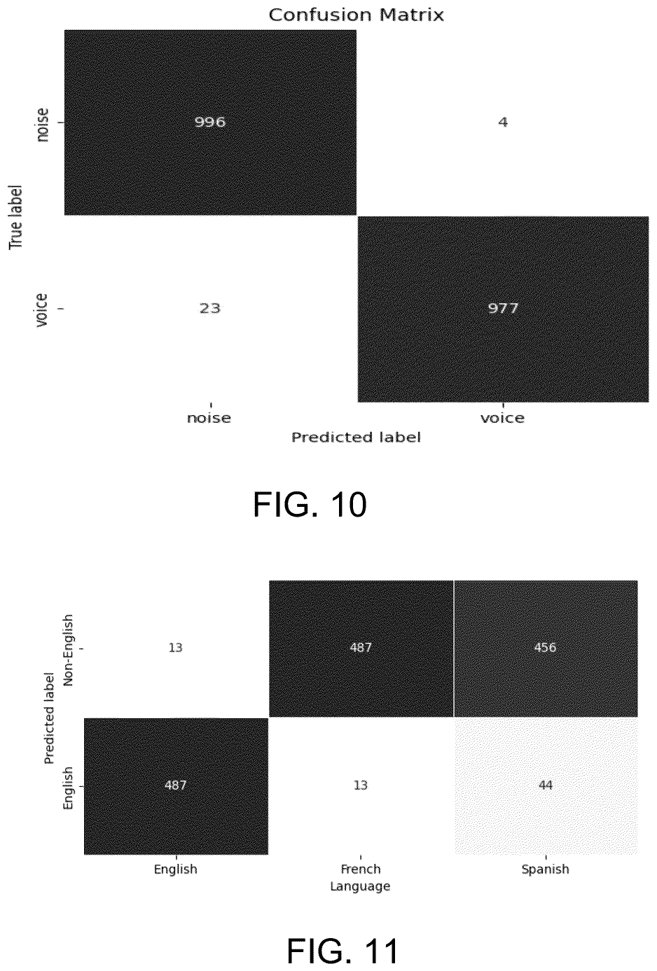

FIG. 10 shows a confusion matrix created using this predictor to compare to the ground truth. This predictor had a 97.7% precision for the noise audio samples. As seen in the confusion matrix, the latent index 15019, associated with noise only audio, demonstrated the latent index can effectively separate noise only audio from speech audio.

Additionally, language was examined by looking at the differences in the latent spaces between Spanish and English samples in the dataset. A simple analysis showed that latent index 5106 enables good discrimination between the two languages. To better understand what this latent index encodes, French samples were also examined and, using the same logic to create a predictor as with the noise above, the precision utilizing this latent to classify non-English was found to be 98.6%.

FIG. 11 shows a confusion matrix showing the three languages and the predictions based on latent index 5106. The latent index 5106 is correlated with non-English speech. Despite French not being included in the SAE training dataset, it was associated with the non-English latent index.

The Whisper encoder 30 used positional encoding which added to the input features, therefore some positional information likely existed in the encoding. However, since the SAE 40 encoded all information as discrete latent indexes, three different positional latents were observed, showing activations on 20 different audio files. These positional latents were temporarily constrained and consistent between distinct files.

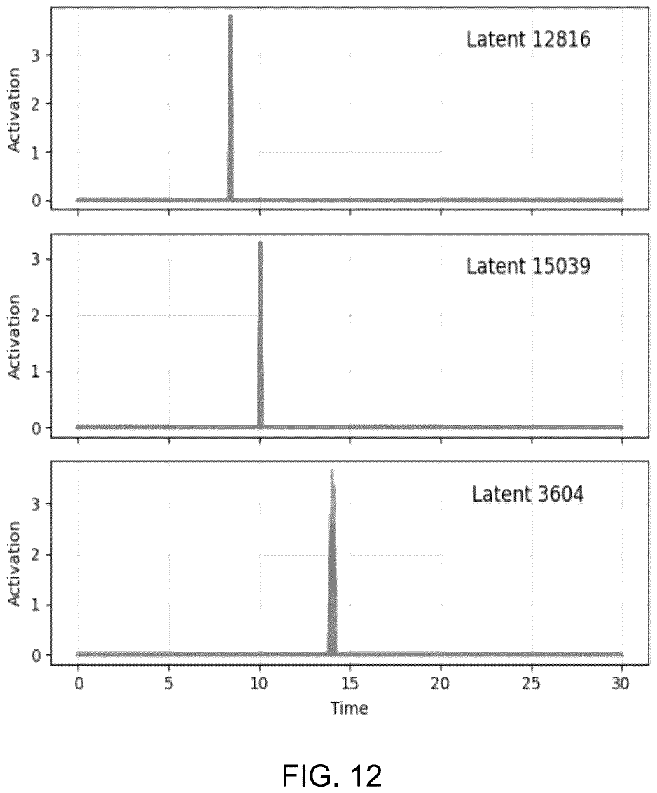

FIG. 12 shows three examples of the positional latent indexes, all of which were tightly located temporally. As seen in the diagram, the latent 12816 in the example had a mean activation timestamp of 8.44 seconds and a standard deviation of 0.19; the latent index 15039 was at 10.09 seconds on average with an SD of 0.04; and the latent index 3604 activated at 14.04 seconds with an SD of 0.37. This positional representation was useful for the decoder to determine word order since the encoding was passed to the decoder with cross-attention.

To properly transcribe the stream of audio in the example, it seemed necessary for Whisper to encode phonetic representations in some manner. Questions relating to whether individual phone-level representations are adequate to process audio or whether rich, context-specific representations are necessary, were also considered. It was understood that this was further complicated by coarticulation—that is, the phenomenon in which the acoustics of phones can change depending on their surrounding phones. This suggested that Whisper may represent the acoustic linguistic stimuli in terms of larger-level representations such as diphones or triphones, rather than individual phones. Indeed, after examining the latent space in the example, it became clear that the AE 30 comprising the Whisper model learned even more complex representations. The SAE 40 had encoded both phones, diphones, and potentially triphones.

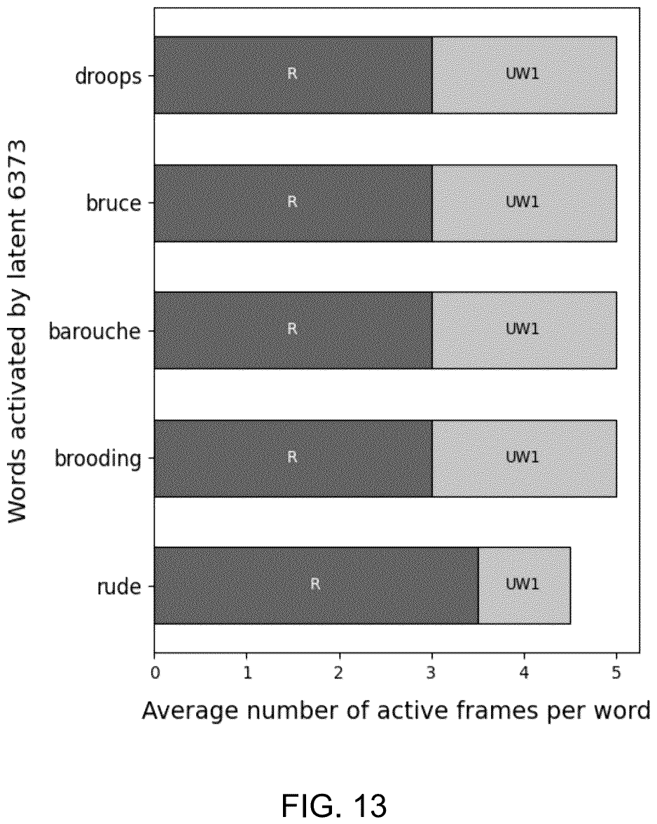

FIG. 13 shows an example of a latent representing the diphone R UW1. In FIG. 13, the top 5 words with the highest average number of frames with latent index 6373 activated (precision value of 0.889). The different shaded bards represent the average amount of activated frames that each phone in the word received. Phones absent in the plot were not activated for this latent.

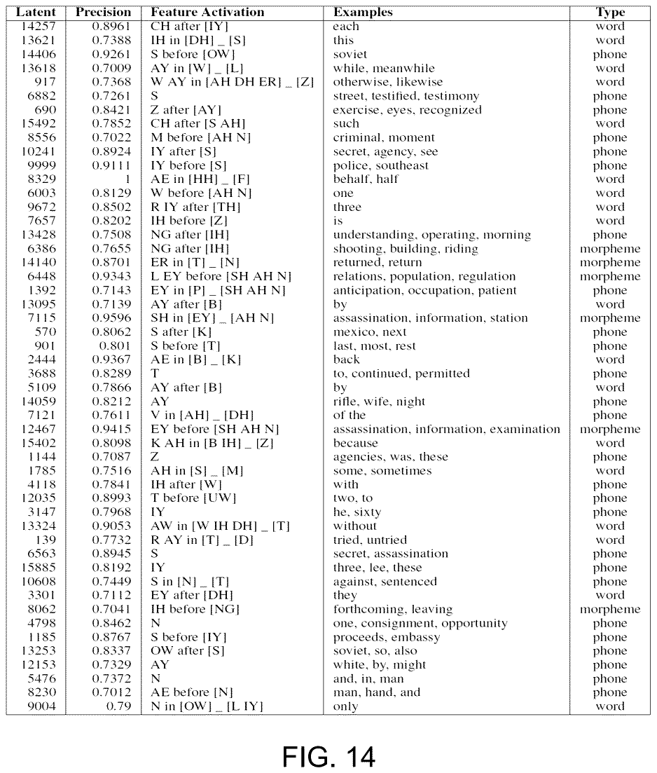

FIG. 14 shows a set of features that the autoencoder 40 in the example learned from the data. As seen in FIG. 14, examples of the latent ID, the precision value, the feature activated (along with their context), and example words containing that feature along with a label (word, phone, or morpheme) are shown. FIG. 14 demonstrates a random sample of 50 latents and a description of what they may represent. This is by no means an exhaustive set, but does demonstrate some of the variability seen in the example in the latent representations. Precision values were calculated by taking the number of frames where the latent was activated for a specific hypothesis (e.g., activated for IY) and dividing it by the total number of times that the latent was activated in general. In other words, the precision values indicated how likely the hypothesized context was to be present when the target latent was activated.

The existence of phonetic features was intuitive given that the system's goal in the example was to transcribe speech. However, word-level features also seemed quite likely, especially in English where there is not a 1-to-1 mapping between orthographic representations and phonetic representations. For example, the letter “ [symbol] ” in (American) ēnglish can represent several different vowels, such as /æ/ (as in cat), / / (as in father), / / (as in cake), / / (as in many), and (as in about). As a result, it may be advantageous for Whisper to encode lexical information in addition to phonetic information. Indeed, this seems to be the case, as we see features that do seem to be convincingly lexical such as latent index 28, which represents the word his and has a precision value of 97.5%.

Linguistic features such as representations of morphological elements are not strictly necessary to transcribe audio, however, given that the sparse autoencoder 40 seemed to encode individual words, the model may also encode other abstract representations. An examination of the SAE 40 confirmed that the model seemed to be learning morphological representations.

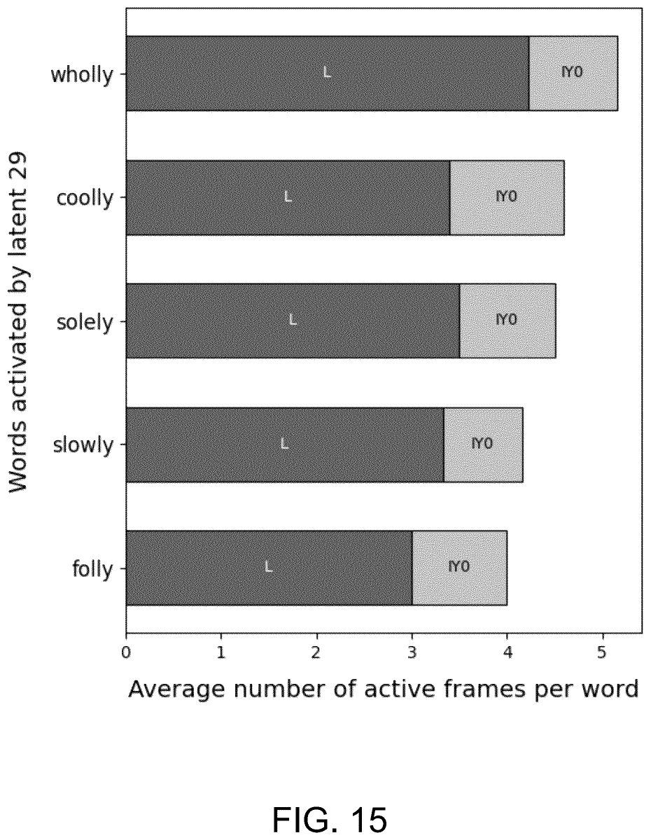

FIG. 15 shows an example that demonstrates the words which have the largest ratio of activated frames for latent index 29. This latent index correlates with the suffix ‘ly’, which in English serves as an adverbial marker (precision value of 95.1%). As seen, the top 5 words with the highest average number of frames with latent index 29 activated (precision value of 0.951). The different shaded bars represent the average amount of activated frames that each phone in the word received. Phones absent in plot were not activated for this latent.

In the example, conceptional representations were not strictly necessary to transcribe audio, however semantics helped identify which words were most appropriate in a given context. Homophones, for example can only by distinguished via context, therefore some level of semantic representation is necessary to disambiguate. Even for words without homophones, excessive noise or other interference could result in poor transcription which can sometimes be resolved with appropriate contextual understanding. In the example, two types of semantic features were explored: Number and Profanity.

Regarding numbers, one prevalent type of semantic feature in the dataset was numerical values. Numbers in audio samples were tagged and examined using the Whisper 30 and autoencoder 40. In Table V, activation of Latent index 7710 is shown which had a strong association with many different numbers with a precision of 86.4%.

TABLE V
Activation of latent index 7710 for samples containing numbers. The darker
highlighting shows a stronger activation value.

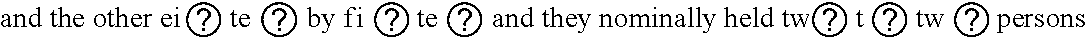

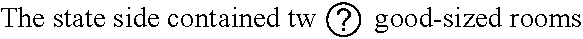

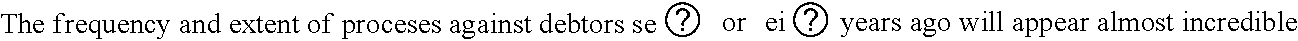

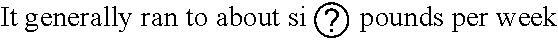

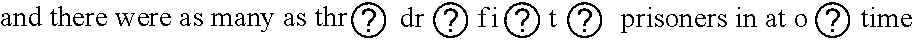

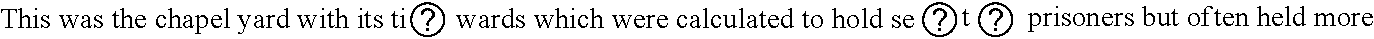

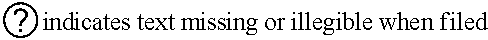

Curse words are another semantic group which can be used in a wide variety of ways and as special intensifiers. This semantic group also seemed to be present upon inspection of the SAE latents. Similar to before, in order to systematically examine this, a set of audios containing swear words was collected from Mozilla Common Voice English. Through examining the encodings of these audio samples, it appeared that Latent index 3584 was an effective identifier of the presence of swear words, demon-strated via Table VI with a precision of 82.7%.

TABLE VI

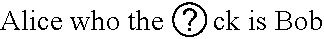

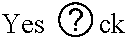

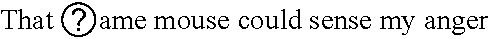

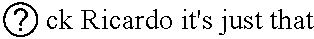

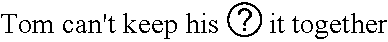

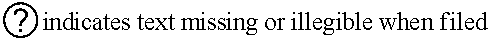

Table VI: Activation of latent index 3584 for samples containing profanity. Both the profanity and number precision values reported here were relatively lower than those of other latents, but there were a few potential reasons for this. One, word alignment may be imperfect meaning the frame which is activated may fall out-side the range of the word. Two, it's possible that especially for semantic features, the activations may not be strongly linked temporally. For example, indications of profanity may be present earlier or later in the utterance due to intonation, intensity and other speech features. Indeed, some utterances show latent index 3584 activations throughout the length of the audio.

In order to more effectively demonstrate that profanity specifically was being detected, steering was employed. By taking the activation of latent index 3584 and setting it to a large negative value where it was previously positive, the curse word can be replaced with a phonetically similar word. This modification can also occasionally change following words, since the Whisper decoder follows the most likely subsequent token. Furthermore, by activating latent index 3584, setting the 0 value to a large positive number, curse words can be inserted. In practice, all of the frames of the encoding have had latent index 3584 activated, leading to the occasional insertion of curse words. Table VII shows a few examples of steering in either direction. As with the de-activation of profanity, swear words seem to appear more often in phonetically similar words.

TABLE VII
Effect of steering latent index 3584 to deactivate and activate profanity.

| | |
|---|---|
| Original | Steered |

Deactivating Profanity Feature

| | |
|---|---|
| Alice, who the fuck is Bob? | Alice, who the focus bar? |
| Yes, fuck. | Yes, Falk. |
| That damn mouse could sense | That dam mouse could sense |
| my anger. | my anger. |
| Fuck Ricardo, it's just that. | If we have a Ricardo, it's just that. |
| Tom can't keep his shit together. | Tom can't keep his sheet together. |

Activating Profanity Feature

| | |
|---|---|
| I want to listen to the track | I want to listen to the track close |
| close to the edge. | to the shit. |
| You need the whole story. | You need the hell of story. |
| We can't leave Greg here. | We can't leave, crap, care. |
| The quick fox jumped on the | The quick fucks jump on the |
| sleeping cat. | sleeping cat. |
| The harder you work, the | The hell you work the fuck you are. |
| luckier you are. | |

Table VII:

Many latent indices may have semantic activations that are independent of language. Since Whisper was trained to be a multilingual ASR, it was possible, in the example, to examine the same effect by collecting audios with curse words in Spanish and French using Mozilla Common Voice. Table VIII demonstrates that the same latent index 3584 was similarly capable of steering in both Spanish and French. It is particularly notable that there were no French audios in the SAE training data.

TABLE VIII
French and Spanish samples steered using latent index 3584
to deactivate profanity.

| | |
|---|---|
| Original | Steered |

French

| | |
|---|---|
| [symbol] | [symbol] |
| [symbol] | [symbol] |
| [symbol] | [symbol] |
| [symbol] | [symbol] |
| [symbol] | [symbol] |

Spanish

| | |
|---|---|
| [symbol] | [symbol] |
| [symbol] | [symbol] |
| [symbol] | [symbol] |
| [symbol] | [symbol] |
| [symbol] | [symbol] |

The example demonstrated that the SAE 40 was effective for inspecting the internal representations of Whisper. The results suggested that Whisper encodes a wide variety of both linguistic and extra-linguistic information, including phonetic, lexical, morphological, semantic, and noise. This is certainly not an exhaustive list, but it nonetheless highlights the usefulness of the SAE 40 for investigating the information encoded in the Whisper encoder. A large number of latents were examined in this example resulting in a long list of features. FIG. 15 shows some notable features discovered.

In various embodiments, the autoencoder suite 40 includes a plurality of autoencoders, including SAEs, built and trained to extract monosemantic features from non-textual embedded data, specifically audio embeddings generated by AE generator 30, such as for example, one or more Titanet models and/or Whisper models. The autoencoders are capable of accurate and comprehensive feature identification, splitting and steering. The autoencoders can be a valuable tool for understanding and interpreting embedded data in many domains, including audio recognition.

The terms “communicating device” or “communication device,” as used in this disclosure, mean any computing device, hardware, or computing resource that can transmit or receive data packets, instruction signals or data signals over a communication link. The communicating device or communication device can be portable or stationary.

The term “communication link,” as used in this disclosure, means a wired or wireless medium that conveys data or information between at least two points. The wired or wireless medium can include, for example, a metallic conductor link, a radio frequency (RF) communication link, an Infrared (IR) communication link, or an optical communication link. The RF communication link can include, for example, WiFi, WiMAX, IEEE 802.11, DECT, 0G, 1G, 2G, 3G, 4G or 5G cellular standards, satellite, or Bluetooth. A communication link can include, for example, an RS-232, RS-422, RS-485, or any other suitable interface.

The terms “computer,” “computing device,” or “processor,” as used in this disclosure, means any machine, device, circuit, component, or module, or any system of machines, devices, circuits, components, or modules that are capable of manipulating data according to one or more instructions. The terms “computer,” “computing device” or “processor” can include, for example, without limitation, a processor, a microprocessor (μC), a central processing unit (CPU), a graphic processing unit (GPU), a data processing unit (DPU), an application specific integrated circuit (ASIC), a general purpose computer, a super computer, a personal computer, a laptop computer, a palmtop computer, a notebook computer, a desktop computer, a workstation computer, a server, a server farm, a computer cloud, or an array or system of processors, μCs, CPUs, GPUs, ASICs, general purpose computers, super computers, personal computers, laptop computers, palmtop computers, notebook computers, desktop computers, workstation computers, or servers.

The term “computer-readable medium,” as used in this disclosure, means any non-transitory storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random-access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “cloud,” which can include a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, or (iii) can be formatted according to numerous formats, standards or protocols, including, for example, WiFi, WiMAX, IEEE 802.11, DECT, 0G, 1G, 2G, 3G, 4G, or 5G cellular standards, or Bluetooth.

The terms “computer resource” or “computing resource,” as used in this disclosure, mean software, a software application, a web application, a web page, a computer application, a computer program, computer code, machine executable instructions, firmware, or a process that can be arranged to execute on a computing device or a communicating device.

The terms “computer resource process” or “computing resource process,” as used in this disclosure, mean a computing resource that is in execution or in a state of being executed on an operating system of a computing device. Each computing resource that is created, opened, or executed on or by the operating system can create a corresponding computing resource process. A computing resource process can include one or more threads, as will be understood by those skilled in the art.

The term “database,” as used in this disclosure, means any combination of software or hardware, including at least one computing resource or at least one computer. The database can include a structured collection of records or data organized according to a database model, such as, for example, but not limited to at least one of a relational model, a hierarchical model, or a network model. The database can include a database management system application (DBMS). The at least one application may include, but is not limited to, a computing resource such as, for example, an application program that can accept connections to service requests from communicating devices by sending back responses to the devices. The database can be configured to run the at least one computing resource, often under heavy workloads, unattended, for extended periods of time with minimal or no human direction.

The terms “including,” “comprising” and variations thereof, as used in this disclosure, mean “including, but not limited to,” unless expressly specified otherwise.

The terms “transmission,” “transmit,” or “send,” as used in this disclosure, mean the conveyance of data, data packets, computer instructions, or any other digital or analog information via electricity, acoustic waves, light waves or other electromagnetic emissions, such as those generated with communications in the radio frequency (RF) or infrared (IR) spectra. Transmission media for such transmissions can include air, coaxial cables, copper wire, or fiber optics, including the wires that comprise a system bus coupled to the processor.

Devices that are in communication with each other need not be in continuous communication with each other unless expressly specified otherwise. In addition, devices that are in communication with each other may communicate directly or indirectly through one or more intermediaries.

Although process steps, method steps, or algorithms may be described in a sequential or a parallel order, such processes, methods and algorithms may be configured to work in alternate orders. In other words, any sequence or order of steps that may be described in a sequential order does not necessarily indicate a requirement that the steps be performed in that order; some steps may be performed simultaneously. Similarly, if a sequence or order of steps is described in a parallel (or simultaneous) order, such steps can be performed in a sequential order. The steps of the processes, methods or algorithms described in this specification may be performed in any order practical.

When a single device or article is described, it will be readily apparent that more than one device or article may be used in place of a single device or article. Similarly, where more than one device or article is described, it will be readily apparent that a single device or article may be used in place of the more than one device or article. The functionality or the features of a device may be alternatively embodied by one or more other devices which are not explicitly described as having such functionality or features.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system for extracting and steering monosemantic features in audio embeddings and for analyzing audio, the system comprising:
an autoencoder having
an input layer configured to receive a dense audio embedding e representing the audio,
an encoder that maps the dense audio embedding e to a latent vector ν,
an activator that constrains activations of the latent vector ν to a subset of indices, and
a decoder that generates a reconstructed embedding ϵ from the constrained latent vector \tilde{ν};
an audio embedding decoder (AED) configured to analyze the reconstructed embedding ϵ and generate an audio-to-text transcript and/or provide identification data, including identification of at least one of (i) a source of the audio, (ii) one or more characteristics of the audio, and (iii) one or more characteristics of the source of the audio; and
a communication unit configured to output or transmit the transcript and/or identification data to a computing device.

2. The system of claim 1, wherein the audio embedding decoder (AED) is configured to identify a monosematic latent feature by correlating a latent index of the constrained latent vector \tilde{v} with a target attribute of the audio.

3. The system of claim 1, wherein the activator is configured to steer the reconstructed embedding ϵ by selectively activating or deactivating the identified latent index to change a relative similarity score of the reconstructed embedding ϵ with respect to reference centroids corresponding to different classes.

4. The system of claim 1, further comprising:
an audio embedding generator configured to transform variable length audio into the dense audio embedding e.

5. The system of claim 4, wherein the dense audio embedding comprises a multidimensional audio embedding and audio embedding generator comprises a convolutional neural network with statistical pooling adapted for audio signals.

6. The system of claim 4, the system further comprising:
an automatic speech recognition (ASR) system comprising a Whisper model that generates the transcript.

7. The system of claim 1, wherein the activator is configured to perform a TopK operation that selects K latent indices of the latent vector ν to be active for a given input.

8. The system of claim 1, wherein the audio embedding decoder (AED) comprises a logistic regression classifier trained on labeled latent activations to identify the latent index.

9. The system of claim 2, wherein the target attribute comprises spoken language and the monosemantic latent feature corresponds to a target language.

10. The system of claim 2, wherein the target attribute comprises music only audio, and the monosemantic latent feature corresponds to interactive voice response (IVR) hold music.

11. The system of claim 2, wherein increasing latent dimensionality causes the monosemantic latent feature to split into subfeatures corresponding to different subpopulations.

12. The system of claim 3, wherein the relative similarity score is computed as a difference of cosine similarities to reference centroids computed from the reconstructed embedding ϵ for labeled datasets.

13. The system of claim 1, wherein the audio embedding decoder (AED) is configured to apply adaptive thresholding to similarity scores to reduce false accepts and false rejects.

14. The system of claim 1, wherein the target attribute is for language-aware routing and the identification data is transmitted to the computing device in a telephony pipeline and pre-ASR language gating to reduce computation and error rates.

15. The system of claim 1, wherein the system is deployable on-device, at an edge, or in a cloud, and is model-agnostic with respect to audio-embedding pipelines.

16. A method for extracting and steering monosemantic features in audio embeddings to analyze audio, the method comprising:
receiving a dense audio embedding representing the audio;
encoding the audio embedding to an expanded latent vector;
applying an activation operation to the expanded latent vector to obtain a sparse latent vector;
decoding the sparse latent vector to generate a reconstructed embedding;
analyzing the reconstructed embedding to identify at least one of (i) a source of the audio, (ii) one or more characteristics of the audio, and (iii) one or more characteristics of the source of the audio; and
outputting identification data to a computing device,
wherein the identification data comprises at least one of (i) the source of the audio, (ii) the one or more characteristics of the audio, and (iii) the one or more characteristics of the source of the audio.

17. The method of claim 16, further comprising:
identifying a monosemantic latent index by training an audio embedding decoder (AED) over latent activations and selecting a top ranked index; and
steering the reconstructed embedding by altering an activation value at the monosemantic latent index to change a relative similarity score between the reconstructed embedding and reference centroids of different classes.

18. The method of claim 16, further comprising:
routing the identification data to the computing device, wherein the routing includes language-aware routing based on the target attribute.

19. The method of claim 16, further comprising:
transforming the audio into the dense audio embedding,
wherein the dense audio embedding comprises a high-dimensional audio embedding.

20. The method of claim 16, wherein applying the activation operation comprises performing a TopK operation that selects K latent indices of the latent vector to be active for a given input.

21. The method of claim 16, wherein the dense audio embedding is received from an automatic speech recognition (ASR) system comprising a Whisper model.
